(19) United States
(12) Patent Application Publication
(10) Pub. No.: US 2013/0229255 A1
(43) Pub. Date: Sep. 5, 2013

(54) NETWORK TRANSFORMER MODULE AND MAGNETIC ELEMENT THEREOF

(71) Applicants: Hua-Sheng SHIH, Taoyuan Hsien (TW); Yu-Sen LIN, Taoyuan Hsien (TW); Tong-Liang NI, Taoyuan Hsien (TW); Ying-Chian KANG, Taoyuan Hsien (TW); Yi-Sheng CHEN, Taoyuan Hsien (TW)

(72) Inventors: Hua-Sheng SHIH, Taoyuan Hsien (TW); Yu-Sen LIN, Taoyuan Hsien (TW); Tong-Liang NI, Taoyuan Hsien (TW); Ying-Chian KANG, Taoyuan Hsien (TW); Yi-Sheng CHEN, Taoyuan Hsien (TW)

(73) Assignee: DELTA ELECTRONICS, INC., TAOYUAN HSIEN (TW)

(21) Appl. No.: 13/612,862

(22) Filed: Sep. 13, 2012

(30) Foreign Application Priority Data
Mar. 5, 2012 (TW) 101107254

(51) Int. Cl. H01F 27/06

(52) U.S. Cl. 336/220

(57) ABSTRACT

A network transformer module includes a first magnetic element, a second magnetic element, and a connection board. The first magnetic element includes a first winding set and a first core, and the first winding set is wound around the first core. The second magnetic element includes a second winding set and a second core, and the second winding set is wound around the second core. The first winding set of the first magnetic element is independent from the second winding set of the second magnetic element, and the first winding set is not wound around the second core. The connection board electrically couples the first winding set with the second winding set. A magnetic element is also disclosed herein.

### RELATED APPLICATIONS

This application claims priority to Taiwan Patent Application Serial Number 101107254, filed Mar. 5, 2012, which is herein incorporated by reference.

### BACKGROUND

1. Technical Field

The present disclosure relates to a transformer. More particularly, the present disclosure relates to a network transformer module.

2. Description of Related Art

In recent years, the technology has been developed and progressed in society, the developed products are correspondingly provided for convenience, certainty and economical benefit, and thus the present developed products are more advanced than those such that they can be contributions to the society.

For a conventional network transformer, in order to give consideration to both functions of transmitting signals and restraining noise, a transformer and a common mode choke for named “common mode inductor”) are usually configured in the network transformer to perform the functions respectively, and the two devices are connected with each other by a conducting wire. Specifically, in fabrication, after the transformer is fabricated with the conducting wire and completed in a winding process, the same conducting wire is utilized in a winding process for the common mode choke, such that the transformer and the common mode choke are electrically connected with each other by the conducting wire.

However, since the two devices are fabricated with the same conducting wire in the winding process, the two devices cannot be fabricated separately, thus causing a minute and complicated fabrication process for the two devices and further resulting in a longer fabrication process for the two devices. Moreover, during the fabrication process, the conducting wire connected between the transformer and the common mode choke tends to be pulled and dragged to be cut off, thus decreasing a yield rate of the products.

Therefore, a heretofore unaddressed need exists in the art to address the aforementioned deficiencies and inadequacies.

### SUMMARY

An aspect of the present disclosure is related to a network transformer module. The network transformer module comprises a first magnetic element, a second magnetic element and a connection board. The first magnetic element comprises a first winding set, a first base and a first core. The first winding set is wound around the first core. The first core is disposed on the first base. At least a portion of the first core is relatively higher than a top surface of the first base. The second magnetic element comprises a second winding set, a second base and a second core. The second winding set is wound around the second core. The second core is disposed on the second base. At least a portion of the second core is relatively higher than a top surface of the second base. The first winding set is independent from the second winding set, and the first winding set is not wound around the second core. The connection board is configured or electrically coupling the first winding set with the second winding set.

Another aspect of the present disclosure is related a magnetic element. The magnetic element comprises a core, a first conducting wire and a second conducting wire. The first conducting wire is wound around the core. The second conducting wire is wound around the core, in which lengths of the first conducting wire and the second conducting wire are different from each other.

Still another aspect of the present disclosure is related to a magnetic element. The magnetic element comprises a core and at least one conducting wire. The core has at least two openings, in which central axes of the openings are nonparallel with each other. The conducting wire is wound around the core.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiments, with reference to the accompanying drawings as follows:

FIG. 1 is a diagram illustrating a network transformer module according to one embodiment of the present disclosure;

FIG. 2 is a diagram illustrating a core assembled by sub-cores according to one embodiment of the present disclosure;

FIG. 3 is a diagram illustrating a network transformer module according to another embodiment of the present disclosure; and

FIG. 4 is a fragmentary circuit diagram illustrating the network transformer module as shown in FIG. 1 according to one embodiment of the present disclosure.

### DESCRIPTION OF THE EMBODIMENTS

In the following description, specific details are presented to provide a thorough understanding of the embodiments of the present disclosure. Persons of ordinary skill in the relevant art will recognize, however, that the present disclosure can be practiced without one or more of the specific details, or in combination with other components. Well-known implementations or operations are not shown or described in detail to avoid obscuring aspects of various embodiments of the present disclosure.

The terms used in this specification generally have their ordinary meanings in the art and in the specific context where each term is used. The use of examples anywhere in this specification, including examples of any terms discussed herein, is illustrative only, and in no way limits the scope and meaning of the disclosure or of any exemplified term. Likewise, the present disclosure is not limited to various embodiments given in this specification.

As used herein, the terms “comprising,” “including,” “having,” “containing,” “involving,” and the like are to be understood to be open-ended, i.e., to mean including but not limited to.

Reference throughout the specification to “one embodiment” or “an embodiment” means that a particular feature, structure, implementation, or characteristic described in connection with the embodiment is included in at least one embodiment of the present disclosure. Thus uses of the phrases “in one embodiment” or “in an embodiment” in various places throughout the specification are not necessarily all referring to the same embodiment. Furthermore, the particular features, structures, implementation, or characteristics may be combined in any suitable manner in one or more embodiments.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may not be in direct contact with each other. “Coupled” may still be used to indicate that two or more elements cooperate or interact with each other.

The term “in perpendicular to” and “in parallel with” also include “substantially in perpendicular to” and “substantially in parallel with”, respectively, throughout the specification and the claims of the present application.

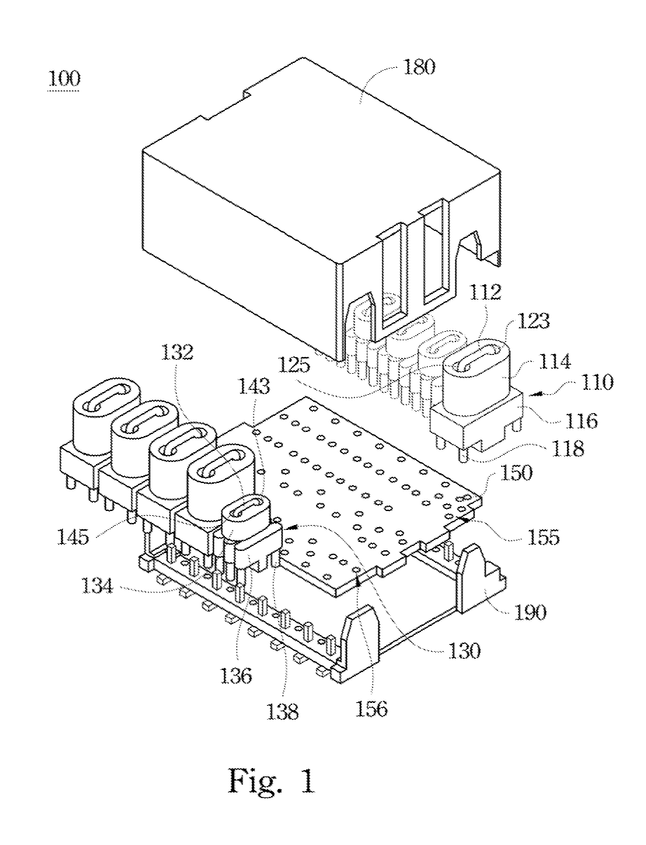

FIG. 1 is a diagram illustrating a network transformer module according to one embodiment of the present disclosure. As shown in FIG. 1, the network transformer module 100 includes a plurality of magnetic elements (e.g., a first magnetic element 110, a second magnetic element 130, etc.), a connection board 150, an outer housing 180 and a bottom plate 190. The magnetic elements are able to be respectively disposed on the connection board 150 by the way of pluggable connection, welding connection or other connections, and then the magnetic elements are assembled with the outer housing 180 and the bottom plate 190 such that they can be packaged together. For convenience of description, the description is exemplarily made as below with the first magnetic element 110 and the second magnetic element 130, but it is not limiting of the present disclosure.

As shown in FIG. 1, the first magnetic element 110 and the second magnetic element 130 can be respectively disposed on the connection board 150 by the way of pluggable connection, welding connection or other connections, such that the first magnetic element 110 and the second magnetic element 130 can be electrically coupled to each other through the connection board 150, and the electrical characteristics of signals transmitted between the first magnetic element 110 and the second magnetic element 130 can thus be consistent.

In one embodiment, the first magnetic element 110 can be a transformer or a common mode choke (or common mode inductor), and the second magnetic element 130 can be a corresponding common mode choke or a corresponding transformer in relative to the first magnetic element 110. For example, when the first magnetic element 110 is the transformer, the second magnetic element 130 is the corresponding common mode choke, and when the first magnetic element 110 is the common mode choke, the second magnetic element 130 is the corresponding transformer. Thus, both functions of transmitting signals and restraining noise can be performed by the first magnetic element 110 and the second magnetic element 130 in the network transformer module 100 at the same time.

In one embodiment, the connection board 150 is a circuit board, a lead frame or a substrate, and the connection board 150 are other supports for the first magnetic element 110 and the second magnetic element 130 to be disposed such that they can be electrically coupled to each other, and thus it is not limiting of the present disclosure.

In the present embodiment, the first magnetic element 110 includes a first winding set 112 and a first core 114 and the first winding set 112 is wound around the first core 114, and the second magnetic element 130 includes a second winding set 132 and a second core 134 and the second winding set 132 is wound around the second core 134, in which the first winding set 112 is independent from the second winding set 132 and not directly coupled with the second winding set 132, and the first winding set 112 is not wound around the second core 134, and the second winding set 132 is not wound around the first core 114.

In addition, as an embodiment, the connection board 150 is configured for electrically coupling the first winding set 112 with the second winding set 132. For example, the first magnetic element 110 further includes a first base 116 and a pin 118, in which the first winding set 112 and the first core 114 are disposed above the first base 116, the first core 114 is disposed on the first base 116, and at least a portion of the first core 114 is relatively higher than a top surface (i.e., the other surface in relative to the surface on which the pin 118 is disposed, of the first base 116) of the first base 116. The pin 118 is disposed below the first base 116 and coupled to the first winding set 112, such that when the pin 118 is disposed on the connection board 150 (for example, the pin 118 passes through a hole 155 of the connection board 150), the first winding set 112 can further be electrically coupled to the connection board 150 through the pin 118.

Similarly, as another embodiment, the second magnetic element 130 her includes a second base 136 and a pin 138, in which the second winding 132 and the second core 134 are disposed above the second base 136, the second core 134 is disposed on the second base 136, and at least a portion of the second core 134 is relatively higher than a top surface (i.e., the other surface in relative to the surface on which the pin 138 is disposed, of the second base 136) of the second base 136. The pin 138 is disposed below the second base 136 and coupled to the second winding set 132, such that when the pin 138 is disposed on the connection board 150 (for example, the pin 138 passes through a hole 156 of the connection board 150), the second winding set 132 can further be electrically coupled to the connection board 150 through the pin 138.

The bases 116 and 136 are provided for the cores 114 and 134, respectively, and therefore not only the first winding set 112 and the second winding set 132 can be effectively supported, but also the connection strength of the connection board 150 connecting with the first magnetic element 110 and the second magnetic element 130 can be enhanced to further increase the yield rate of the products and provide stable electrical characteristics.

Furthermore, as an embodiment, the first winding set 112 and the second winding set 132 also directly pass through the holes (e.g., the holes 155 and 156) of the connection board 150, and thus production costs can be reduced significantly.

On the other hand, a wire of the first winding set 112 may be the same as or different from a wire of the second winding set 132 in diameter or length, and persons of ordinary skill in the art can only select an appropriate diameter of a wire according to practical needs. When the diameters or lengths of the wires of the first winding set 112 and the second winding set 132 are changed, or even the diameter or length of the wire of the first winding set 112 is different from the diameter or length of the wire of the second winding set 132, the insertion loss can be correspondingly modified and improved.

The first winding set 112 and the second winding set 132 are electrically coupled to each other through the connection board 150, such that the first magnetic element 110 and the second magnetic element 130 need not be connected with each other by the conducting wire which has a length that is difficult to be controlled, for avoiding the issue that the two magnetic elements are fabricated with the same conducting wire in a winding process and thus cannot be manufactured separately, so as to shorten the process time for achieving the automated production, and also to prevent the conducting wire connected between the two magnetic elements from being cut off.

In one embodiment, the first core 114 or the second core 134 has N openings for the winding set to be wound, in which N is a positive integer. For example, as shown in FIG. 1, the first core 114 has two openings 123, 125 for the first winding set 112 to be wound, and the second core 134 has two openings 143, 145 for the second winding set 132 to be wound. In practice, the number of openings of the first core 114 and the second core 134 can be increased appropriately, and when the number of openings of the core is increased, the strength of magnetic field can thus be enhanced effectively.

In another embodiment, the first core 114 or the second core 134 has at least two openings, and central axes of the openings are nonparallel with each other. For example, central axes of the openings 123, 125 of the first core 114 are nonparallel with each other, or central axes of the openings 143, 145 of the second core 134 are nonparallel with each other. In other words, the central axes of the openings of the same core can be in parallel with each other or nonparallel with each other, and the central axes of the openings of different cores can be in parallel with each other or nonparallel with each other as well.

As mentioned above, different numbers, sizes or shapes of openings of the core can be designed and used for the winding set according to practical needs, by persons of ordinary skill in the art, and thus FIG. 1 is not limiting of the present disclosure.

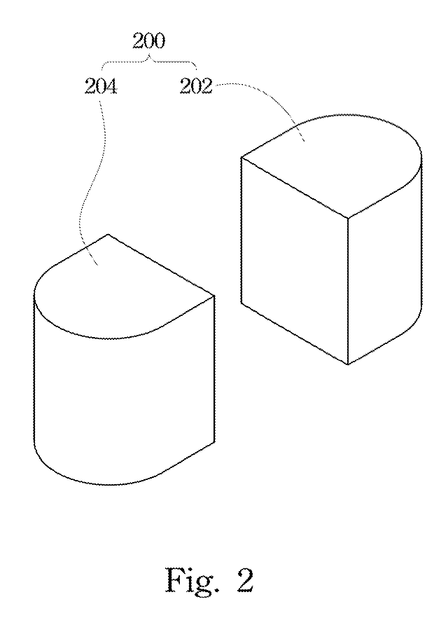

In one embodiment, the first core 114 or the second core 134 may further include M sub-cores, and M is a positive integer which is greater than 1. In another embodiment, a shape of any one of the sub-cores can be the E shape, the P shape, the I shape, the C shape, the H shape, the U shape, the L shape, or the ring shape. For example, FIG. 2 is a diagram illustrating a core assembled by sub-cores according to one embodiment of the present disclosure, in which a core 200 is assembled by two sub-cores 202, 204.

Notably, the number and shape of the sub-cores as shown in FIG. 2 are merely illustrative but not limiting of the present disclosure, and the number and shape of the sub-cores and the manner of assembling the same can be designed and selected according to practical needs by persons of ordinary skill in the art, in order to implement the first core 114 or the second core 134.

In one embodiment, the first winding set 112 or the second winding set 132 further includes P conducting wires, and P is a positive integer. For example, the first winding set 112 or the second winding set 132, as shown in FIG. 1, is fabricated with a single conducting wire.

In addition, when the first winding set 112 or the second winding set 132 includes P conducting wires (i.e., when P is the positive integer of 2 or greater than 2), lengths of at least two of the conducting wires of the first winding set 112 or the second winding set 132 may be different from each other; in other words, at least two of the conducting wires can be configured to have different lengths. In another embodiment, the lengths of all of the conducting wires of the first winding set 112 or the second winding set 132 are different from each other. When the lengths of at least two of the conducting wires are different from each other, the insertion loss can be and effectively improved.

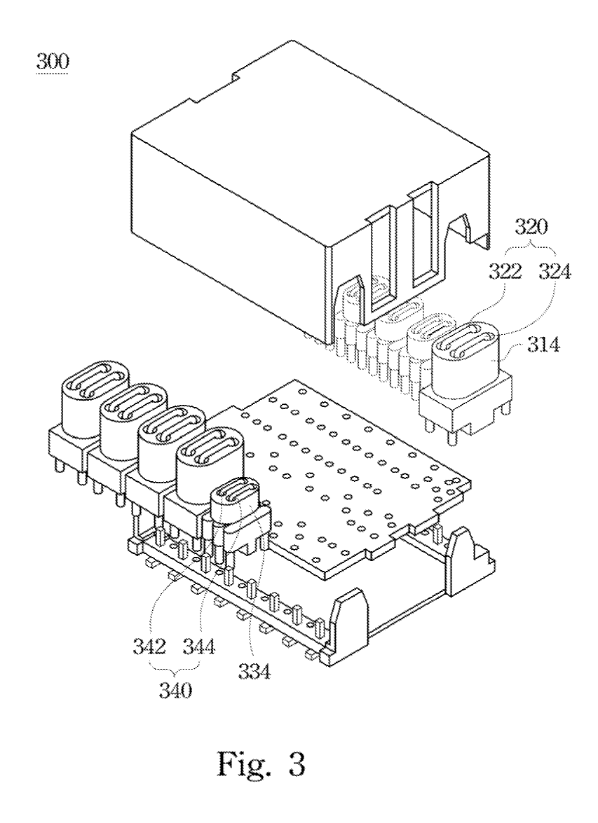

One specific embodiment is shown in FIG. 3 which is a diagram illustrating a network transformer module according to another embodiment of the present disclosure. In the network transformer module 300 of the present embodiment, a first winding set 320 includes a first conducting wire 322 and a second conducting wire 324, the first conducting wire 322 and the second conducting wire 324 are wound around a first core 314, a second winding set 340 includes a third conducting wire 342 and a fourth conducting wire 344, and the third conducting wire 342 and the fourth conducting wire 344 are wound around a second core 334, in which lengths of the first conducting wire 322 and the second conducting wire 324 are different from each other, or lengths of the third conducting wire 342 and the fourth conducting wire 344 are different from each other. In another embodiment, the lengths of the first conducting wire 322, the second conducting wire 324, the third conducting wire 342 and the fourth conducting wire 344 can be selectively designed to be all the same, partially the same or different from each other. The corresponding lengths of the aforementioned conducting wires can be designed according to practical needs by persons of ordinary skill in the art, and thus it is not limiting of the present disclosure.

The features of the magnetic elements in the embodiments mentioned above can be formed individually or formed together. Specifically, the first core 114 or the second core 134 may have a plurality of openings, and the first core 114 or the second core 134 may further include a plurality of sub-cores. Therefore, the features in the respective embodiments are individually described for convenience of description, all of the embodiments can be selectively collocated to implement the magnetic elements in the present disclosure, and thus the respective embodiments are not intended to be limiting of the present disclosure.

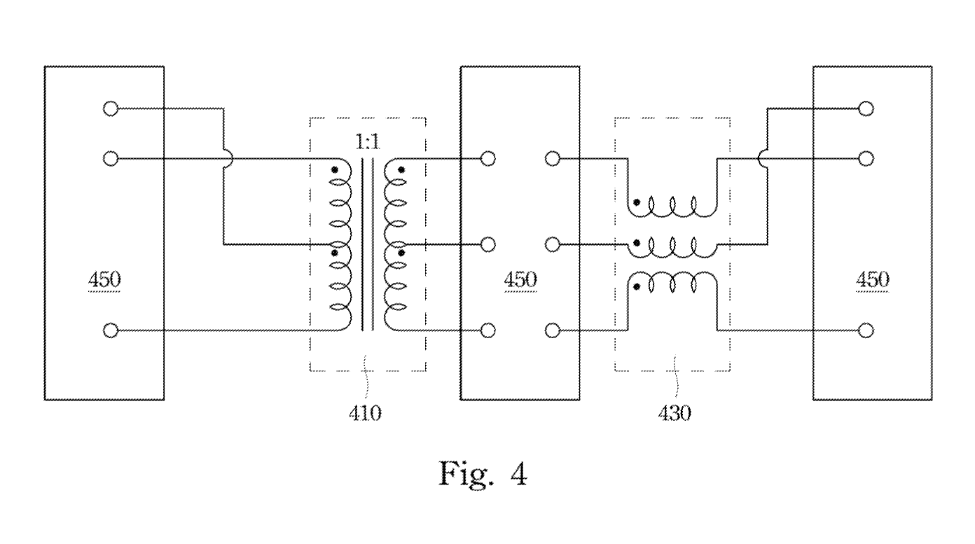

FIG. 4 is a fragmentary circuit diagram illustrating the network transformer module as shown in FIG. 1 according to one embodiment of the present disclosure. As shown in FIG. 4, a first magnetic element 410 (e.g., a transformer) and a second magnetic element 430 (e.g., a common mode choke) are not directly coupled to each other but are electrically coupled to a connection board 450 respectively by the way of pluggable connection, welding connection or other connections, such that first magnetic element 410 and the second magnetic element 430 are electrically coupled to each other through the connection board 450.

Given the foregoing embodiments of the present disclosure, it is known that the network transformer module and the magnetic element therein not only simultaneously realize both functions of transmitting signals and restraining noise, but also make the electrical characteristics of signals transmitted between different magnetic elements consistent. In addition, two magnetic elements need not be connected with each other via the conducting wire and can be manufactured separately, so as to shorten the process time for achieving the automated production, and also to prevent the conducting wire connected between the two magnetic elements from being cut off. Furthermore, by changing the diameters or lengths of the wires of the winding set in the magnetic element, the insertion loss can be correspondingly modified and improved.

As is understood by a person skilled in the art, the foregoing embodiments of the present disclosure are illustrative of the present disclosure rather than limiting of the present disclosure. It is intended to cover various modifications and similar arrangements included within the spirit and scope of the appended claims, the scope of which should be accorded with the broadest interpretation so as to encompass all such modifications and similar structures.

What is claimed is:

1. A network transformer module comprising:
a first magnetic element comprising a first winding set, a first base and a first core, the first winding set wound around the first core, the first core disposed on the first base, at least a portion of the first core being relatively higher than a top surface of the first base;
a second magnetic element comprising a second winding set, a second base and a second core, the second winding set wound around the second core, the second core disposed on the second base, at least a portion of the second core being relatively higher than a top surface of the second base, wherein the first winding set is independent from the second winding set, and the first winding set is not wound around the second core; and
a connection board for electrically coupling the first winding set with the second winding set.

2. The network transformer module as claimed in claim 1, wherein the first core or the second core comprises M sub-cores, and M is a positive integer greater than 1.

3. The network transformer module as claimed in claim 1, wherein the first core or the second core has N openings, and N is a positive integer.

4. The network transformer module as claimed in claim 1, wherein the first winding set or the second winding set comprises P conducting wires, and P is a positive integer.

5. The network transformer module as claimed in claim 4, wherein when P is the positive integer being 2 or greater than 2, lengths of at least two of the conducting wires are different from each other.

6. The network transformer module as claimed in claim 1, wherein the first core or the second core has at least two openings, and central axes of the openings are nonparallel with each other.

7. The network transformer module as claimed in claim 1, wherein a wire of the first winding set is different from a wire of the second winding set in diameter or length.

8. The network transformer module as claimed in claim 1, wherein the connection board is a circuit board, a lead frame or a substrate.

9. A magnetic element comprising:
a core;
a first conducting wire wound around the core; and
a second conducting wire wound around the core, wherein lengths of the first conducting wire and the second conducting wire are different from each other.

10. A magnetic element comprising:
a core having at least two openings, wherein central axes of the openings are nonparallel with each other; and
at least one conducting wire wound around the core.
